(19) United States
(12) Patent Application Publication
(10) Pub. No.: US 2021/0162487 A1
(43) Pub. Date: Jun. 3, 2021

(54) METHOD OF MANUFACTURING HYDRAULIC CYLINDER ROD

(71) Applicant: SHPAC CO., LTD, Busan (KR)

(72) Inventors: Yun Ju LEE, Yongin-Si (KR); Hye Kyeong LEE, Changwon-Si (KR); Tae Ho HWANG, Busan (KR)

(73) Assignee: SHPAC CO., LTD

(21) Appl. No.: 17/169,727

(22) Filed: Feb. 8, 2021

Related U.S. Application Data
(63) Continuation of application No. PCT/KR2019/013797, filed on Oct. 21, 2019.

(30) Foreign Application Priority Data
Sep. 25, 2019 (KR) 10-2019-0118205

(51) Int. Cl. B21K 1/10

(52) U.S. Cl. CPC B21K 1/10

(57) ABSTRACT

Proposed is a method of manufacturing a hydraulic cylinder rod, the method including the step of deriving an optimal ratio between a metal tube and a composite material round rod when preparing a hybrid round rod by inserting the composite material round rod into the metal tube in order to reduce the weight of an existing metal round rod such as a cylinder rod of a hydraulic cylinder, whereby the hybrid round rod is prepared through the step and then a rod eye is coupled to the hybrid round rod to manufacture the hydraulic cylinder rod.

### REFERENCE TO RELATED APPLICATIONS

This is a continuation of International Patent Application PCT/KR2019/013797 filed on Oct. 21, 2019, which designates the United States and claims priority of Korean Patent Application No. 10-2019-0118205 filed on Sep. 25, 2019, the entire contents of which are incorporated herein by reference.

### FIELD OF THE INVENTION

The present disclosure relates generally to a method of manufacturing a hydraulic cylinder rod. More particularly, the present disclosure relates to a method of manufacturing a hydraulic cylinder rod, the method including the step of deriving an optimal ratio between a metal tube and a composite material round rod when manufacturing a hybrid round rod by inserting the composite material round rod into the metal tube in order to reduce the weight of an existing hydraulic cylinder rod.

### BACKGROUND OF THE INVENTION

A hydraulic cylinder is a core component of construction equipment, heavy equipment, high place operation cars. Recently, the need to develop a lightweight hydraulic cylinder has arisen.

If the weight of the hydraulic cylinder is reduced by 30%, the total weight of construction equipment and high place operation cars can be reduced by 6 to 15%, which can improve energy efficiency in equipment operation, and thus the development of lightweight hydraulic cylinders is attracting attention.

In order to reduce the weight of such hydraulic cylinders, a cylinder tube and a rod are each entirely or partially made of carbon fiber reinforced plastic (CFRP), which is a high-tech plastic composite material that is attracting attention as a high-strength, high-elasticity, and lightweight structural material.

In particular, in the case of a round cylinder rod, a CFRP round rod is inserted into a metal tube, so that the rod is manufactured as a hybrid round rod in which a metal material and CFRP are mixed, thereby realizing weight reduction.

However, in order to achieve weight reduction while satisfying a target buckling load in manufacturing the hybrid round rod, it is necessary to calculate an appropriate ratio between metal and CFRP, but research and development on a method of calculating such a ratio is insufficient.

Therefore, there is a need to develop a technology capable of presenting an optimal ratio between heterogeneous materials of a hybrid round rod so as to contribute to the development of a lightweight hydraulic cylinder.

### SUMMARY OF THE INVENTION

Accordingly, the present disclosure has been made keeping in mind the above problems occurring in the related art, and an objective of the present disclosure is to provide a method of manufacturing a hydraulic cylinder rod, the method including the step of deriving an optimal ratio between a metal tube and a composite material round rod when preparing a hybrid round rod by inserting the composite material round rod into the metal tube in order to reduce the weight of an existing metal round rod such as a cylinder rod of a hydraulic cylinder, whereby the hybrid round rod is prepared through the step and then a rod eye is coupled to the hybrid round rod to manufacture the hydraulic cylinder rod.

In order to achieve the above objective, according to one aspect of the present disclosure, there is provided a method of manufacturing a lightweight hydraulic cylinder rod using a hybrid round rod including a metal tube and a composite material round rod provided inside the metal tube, the method including: (a) selecting specifications of the hybrid round rod, selecting a population for the metal tube within a range of the specifications, and calculating a thickness of the metal tube that can reduce a weight of the hybrid round rod in the population to derive an optimal ratio between the metal tube and the composite material round rod; (b) preparing the metal tube and the composite material round rod according to the optimal ratio derived in the step (a) and integrating the metal tube and the composite material round rod together to prepare a lightweight hybrid round rod; and (c) coupling a rod eye to the lightweight hybrid round rod.

According to a preferred embodiment of the present disclosure, the step (a) may include: (a-1) setting a first outer diameter OD1, a length L, a set buckling load F, an end condition factor n, and a first safety factor SF1 of the hybrid round rod, and setting material and modulus of elasticity E of the metal tube; (a-2) selecting a population for a thickness value of the metal tube in a range equal to or less than the first outer diameter OD1, and calculating a slenderness ratio using the selected population for the thickness value and the length L to determine a method for calculating a critical buckling load PC of the population for the thickness value; (a-3) calculating the critical buckling load PC for the population for the thickness value and a second safety factor SF2 using the determined method, and calculating a third safety factor SF3 closest to the first safety factor SF1 among calculated second safety factors SF2; and (a-4) deriving the optimal ratio between the metal tube and the composite material round rod by using, as an optimal thickness, the thickness of the metal tube that can reduce the weight of the hybrid round rod among thickness values of the metal tube in the population for the thickness value, the thickness values corresponding to the third safety factor SF3.

According to another preferred embodiment of the present disclosure, the population for the thickness value of the metal tube in the step (a-2) may be formed by selecting the first outer diameter OD1 as a value of an outer diameter ODm of the metal tube, and selecting at least one of values in a range equal to or less than the selected value of the outer diameter ODm of the metal tube as a value of an inner diameter IDm of the metal tube.

According to still another preferred embodiment of the present disclosure, the method for calculating the critical buckling load PC of the metal tube in the step (a-2) may use either Rankine's method or Eulers method according to the calculated slenderness ratio.

According to yet another preferred embodiment of the present disclosure, the step (a-4) may be performed by calculating an outer diameter ODc of the composite material round rod from the optimal thickness of the metal tube, and calculating a ratio of the composite material round rod by using the calculated outer diameter ODc of the composite material round rod and an outer diameter ODm of the metal tube.

As described above, according to the present disclosure, the following effects can be expected.

As it is possible to derive the optimal ratio between heterogeneous materials that can realize weight reduction while satisfying a target buckling load when manufacturing a hybrid round rod, it is possible to contribute to reduction of the weight of metal round rods and the weight of related apparatuses.

### BRIEF DESCRIPTION OF THE DRAWINGS

FIG. 1 is a view illustrating a hybrid round rod according to the present disclosure.

FIG. 2 is a flow chart illustrating a method of manufacturing a hydraulic cylinder rod according to the present disclosure.

FIG. 3 is a table illustrating data calculated by selecting values of an outer diameter ODm and an inner diameter IDm of a metal tube as a population of Example 1.

FIG. 4 is a table illustrating the results according to Example 1 of the present disclosure.

FIG. 5 is a table illustrating data calculated by selecting values of an outer diameter ODm and an inner diameter IDm of a metal tube as a population of Example 2.

FIG. 6 is a table illustrating the results according to Example 2 of the present disclosure.

FIG. 7 is a view illustrating a step in which a rod eye is coupled to an end of the lightweight hybrid round rod according to the present disclosure.

### DETAILED DESCRIPTION OF THE INVENTION

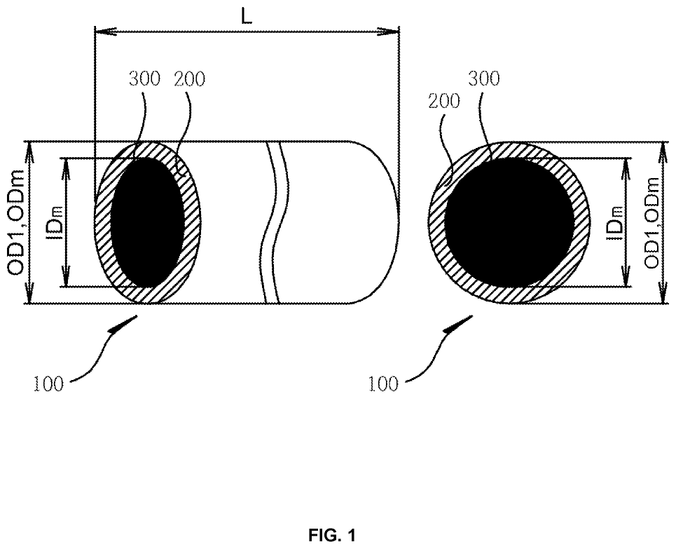

As illustrated in FIG. 1, a hybrid round rod 100 according to the present disclosure includes a metal tube 200 and a composite material round rod 300 inserted and fixed inside the metal tube 200, and an outer diameter OD1 of the hybrid round rod 100 includes a thickness ODm-IDm of the metal tube 200 and an outer diameter ODc of the composite material round rod 300.

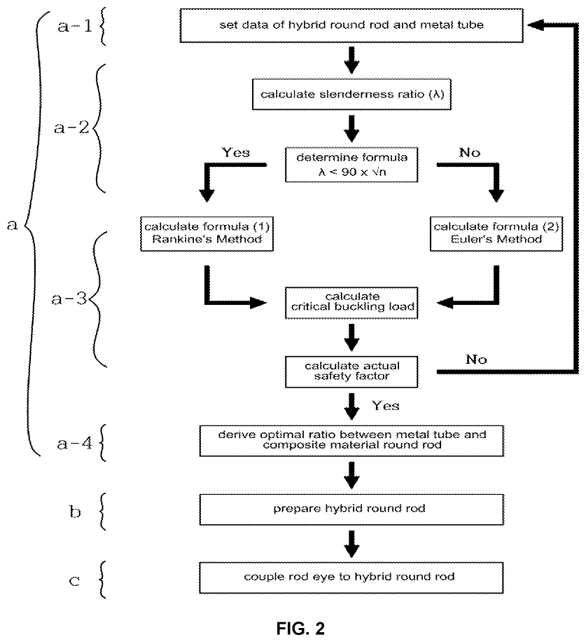

As illustrated in FIG. 2 in conjunction with the above-described drawing, a method of manufacturing a rod of a lightweight hydraulic cylinder with the hybrid round rod 100 including the metal tube 200 and the composite material round rod 300 includes the following steps.

First, step (a) is performed, in which specifications of the hybrid round rod 100 are selected, a population for the metal tube 200 is selected within the range of the specifications, and a thickness of the metal tube 200 that can reduce the weight of the hybrid round rod 100 is calculated in the population to derive an optimal ratio between the metal tube 200 and the composite material round rod 300.

Next, a step, in which the metal tube 200 and the composite material round rod 300 are prepared according to the optimal ratio derived in step (a) and integrated together to prepare a lightweight hybrid round rod 100, is performed.

Subsequently, a step, in which a rod eye is coupled to the lightweight hybrid round rod 100, is performed to manufacture a lightweight hydraulic cylinder rod.

Hereinafter, exemplary embodiments of the present disclosure will be described in detail with reference to the accompanying drawings. Prior to the description, advantages and features of the present disclosure and methods of achieving the advantages and features will be clear with reference to embodiments described in detail below when taken in conjunction with the accompanying drawings. Terms used in this specification are for the purpose of describing the embodiments and thus should not be construed as limiting the present disclosure, and it is noted that the singular forms are intended to include the plural forms as well, unless the context clearly indicates otherwise. Further, in the description, a term indicating the direction is for aiding understanding of the description and can be changed according to the viewpoint.

The present disclosure is to provide a method of manufacturing a hydraulic cylinder rod, the method including the step of deriving an optimal ratio between a metal tube and a composite material round rod when preparing a hybrid round rod by inserting the composite material round rod into the metal tube in order to reduce the weight of an existing metal round rod such as a cylinder rod of a hydraulic cylinder, whereby the hybrid round rod is prepared through the step and then a rod eye is coupled to the hybrid round rod to manufacture the hydraulic cylinder rod.

In deriving the optimal ratio between the metal tube and the composite material round rod according to the present disclosure, it is noted that the physical properties of the composite material round rod and the numerical values for strength against buckling are presented for reference only as data obtained from the results of a buckling test performed on a hybrid round rod composed of a metal tube and a composite material round rod. It is also noted that the units of weight and length are kg and mm unless otherwise specified.

As illustrated in FIG. 1, a hybrid round rod 100 according to the present disclosure includes a metal tube 200 and a composite material round rod 300 inserted and fixed inside the metal tube 200, and an outer diameter OD1 of the hybrid round rod 100 includes a thickness ODm-IDm of the metal tube 200 and an outer diameter ODc of the composite material round rod 300.

As illustrated in FIG. 2 in conjunction with the above-described drawing, a method of manufacturing a rod of a lightweight hydraulic cylinder with the hybrid round rod 100 including the metal tube 200 and the composite material round rod 300 includes steps (a), (b), and (c).

Step (a) is a step in which specifications of the hybrid round rod 100 and the metal tube 200 included in the hybrid round rod 100, such as physical properties and dimensions such as length, are selected, a population for the metal tube 200 is selected within the range of the specifications, and a thickness of the metal tube 200 that can reduce the weight of the hybrid round rod 100 while satisfying the specifications thereof is calculated to derive an optimal ratio between the metal tube 200 and the composite material round rod 300.

This step (a) includes steps (a-1), (a-2), (a-3) and (a-4).

First, step (a-1) is a step in which a first outer diameter OD1, which is a set outer diameter, a length L, a set buckling load F, an end condition factor n, and a first safety factor SF1, which is a set safety factor, of the hybrid round rod 100 are set, and specifications such as material, modulus of elasticity E, and density of the metal tube 200 are set.

In other words, in step (a), data for deriving the optimal ratio of the composite material round rod 300 is calculated by setting specifications of each of the hybrid round rod 100 and the metal tube 200.

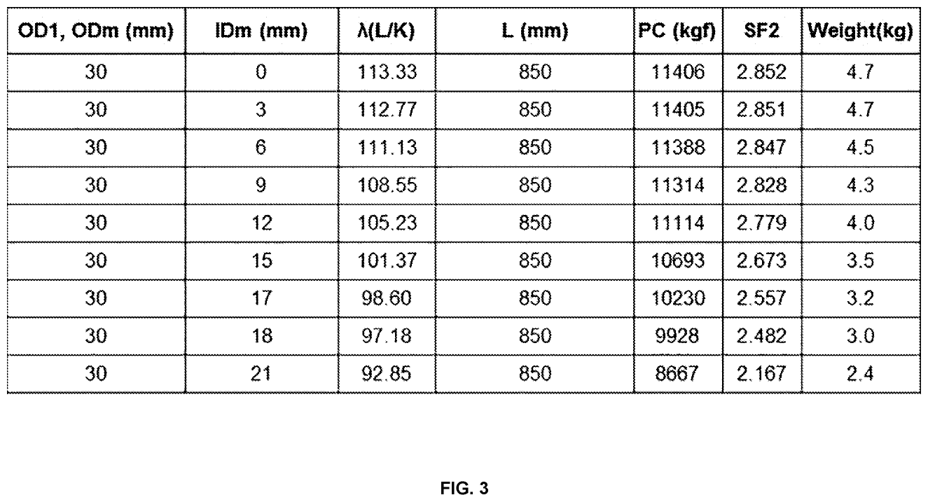

Next, as illustrated in FIG. 3, step (a-2) is a step in which a population for a thickness value of the metal tube 200 is selected in the range equal to or less than the first outer diameter OD1, and a slenderness ratio A is calculated using the selected population for the thickness value and the length L to determine a method for calculating a critical buckling load PC of the population for the thickness value.

In the population for the thickness value of the metal tube 200, one of values in the range equal to or less than the first outer diameter OD1 is selected as a value of an outer diameter ODm of the metal tube 200. Here, the first outer diameter OD1 which is the set outer diameter of the hybrid round rod 100 and the outer diameter ODm of the metal tube 200 are selected to be the same.

The population for the thickness value of the metal tube 200 is formed by selecting values in the range equal to or less than the outer diameter ODm of the metal tube 200 as values of an inner diameter IDm of the metal tube 200 and selecting a plurality of values of the inner diameter IDm of the metal tube 200 for the selected value of the outer diameter ODm of the metal tube 200.

Here, the outer diameter ODm of the metal tube 200 is a value of the first outer diameter OD1, which is the set outer diameter of the hybrid round rod 100, and when the first outer diameter OD1 is 30 mm, may be equal to this value. In addition, the inner diameter IDm of the metal tube 200 includes values in the range equal to or less than the outer diameter ODm of the metal tube 200, and may include all length values of equal to or less than 30 mm.

In step (a-2), the slenderness ratio A is calculated by Formula 1 below using the length L, the values of the outer diameter ODm of the metal tube 200, and the values of the inner diameter IDm of the metal tube 200, and the method for calculating the critical buckling load PC of the metal tube 200 according to each of the respective calculated values of the slenderness ratio A is determined.

In other words, when each of the calculated values of the slenderness ratio A falls within the range of Formula 2, the critical buckling load PC of the metal tube 200 is calculated using Rankine's method as in Formula 4, and when each of the values of the slenderness ratio A falls within the range of Formula 3, the critical buckling load PC of the metal tube 200 is calculated using Euler's method as in Formula 5.

$$\begin{matrix}λ = \frac{L}{k} = \frac{4 \times L}{\sqrt{{ODm}^{2} + {IDm}^{2}}} & [ Formula 1 ] \\ λ < 90 \times \sqrt{n} & [ Formula 2 ] \\ λ \geq 90 \times \sqrt{n} & [ Formula 3 ] \\ PC = \frac{{σ}_{C} \times Ar}{1 + \frac{a}{n} \times {( \frac{L}{K} )}^{2}} & [ Formula 4 ] \\ PC = \frac{n \times {π}^{2} \times E \times I}{{L}^{2}} & [ Formula 5 ]\end{matrix}$$

Subsequently, as illustrated in FIGS. 1 to 3, step (a-3) is a step in which in which the critical buckling load PC, and a second safety factor SF2 of the metal tube 200 are calculated using the determined method for calculating the critical buckling load PC and each of the values of the outer diameter ODm of the metal tube 200 and values of the inner diameter IDm of the metal tube 200 selected from the population for the thickness value, and a third safety factor SF3 of the metal tube 200 closest to the first safety factor SF1 among the calculated respective second safety factors SF2 is calculated.

Here, each of the second safety factors SF2 is a value calculated for the length L and each of the values of the outer diameter ODm of the metal tube 200 and values of the inner diameter IDm of the metal tube 200 selected from the population for the thickness value, and the third safety factor SF2 is a value closest to the first safety factor SF1 among the calculated second safety factors SF2.

Here, if the calculated value of the slenderness ratio A falls within the range to which the Euler's method should be applied and thus the critical buckling load PC is calculated using Euler's method, the value of the slenderness ratio A may fall within the range to which Rankine's method should be applied in the course of gradually decreasing the values of the inner diameter IDm of the metal tube 200. In this case, a value of the critical buckling load PC calculated using Euler's method and a value of the critical buckling load PC calculated using Rankine's method cannot be organically linked because these values are for hybrid round rods of different structures under the structural boundary conditions of the hybrid round rods. Therefore, if the critical buckling load PC is calculated using Euler's method and is calculated using Rankine's method as the values of the inner diameter IDm of the metal tube 200 are gradually decreased, the critical buckling load PC calculated using Rankine's method should be interpreted separately from the critical buckling load PC calculated using Euler's method.

Next, as illustrated in FIGS. 1 to 4, step (d) is a step in which the optimal ratio between the metal tube 200 and the composite material round rod 300 is derived by using the thickness that can reduce the weight of the hybrid round rod 100 among thickness values of the metal tube 200 [values of the outer diameter ODm and values of the inner diameter IDm] selected from the population for the thickness value, the thickness values corresponding to the third safety factor SF3.

In step (a-4), as described above, since the present disclosure is for calculating the optimal ratio between the metal tube 200 and the composite material round rod 300 for weight reduction without taking into account the physical properties of the composite material round rod 300 and its strength against buckling, a thickness Tm of the metal tube 200 that satisfies the first safety factor SF1 can be derived by using values of the outer diameter ODm and inner diameter IDm of the metal tube 200 corresponding to the third safety factor SF3.

Therefore, the outer diameter ODc of the composite material round rod 300 is calculated using the value of the inner diameter IDm of the metal tube 200 from the thickness Tm of the metal tube 200 that satisfies the first safety factor SF1, and the optimal ratio of the composite material round rod 300 to the hybrid round rod 100 is calculated by Equation 6 below using the calculated outer diameter ODc of the composite material round rod 300.

$$Ratio = \frac{ODc}{ODm} \times 100 \qquad [ Formula 6 ]$$

Next, step (b) is a step in which the metal tube 200 and the composite material round rod 300 are prepared according to the optimal ratio derived in step (a-4) and integrated together to prepare a lightweight hybrid round rod 100.

In this step (b), the composite material round rod 300 is integrated into the prepared metal tube 200 by a bonding method. On the other hand, the metal tube 200 may be uniformly heated in the entire area while being rotated to thermally expand the inner diameter thereof to a dimension greater than the outer diameter of the composite material round rod 300, and in this state, the composite material round rod 300 is shrink-fitted into the metal tube 200, followed by cooling to integrate the metal tube 200 and the composite material round rod 300.

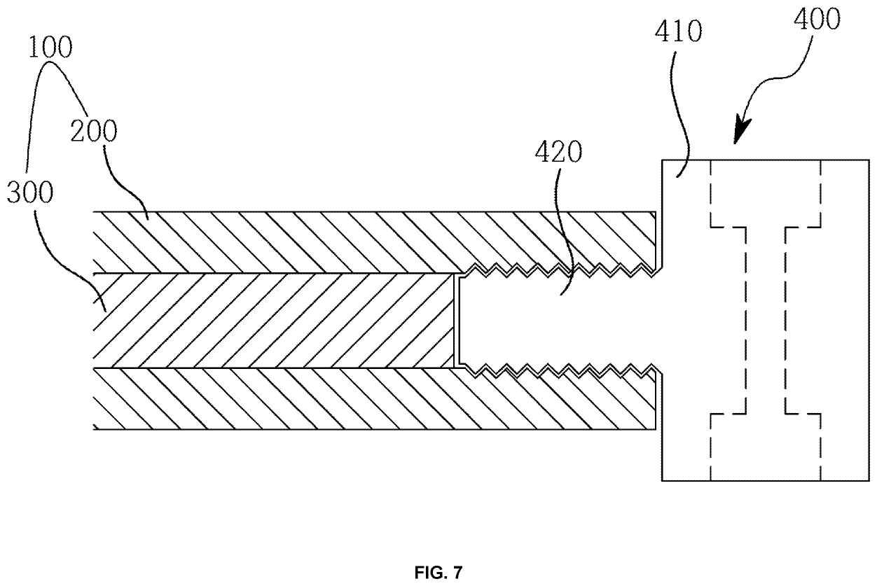

Finally, as illustrated in FIG. 7, step (c) is a step in which a rod eye 400 is coupled to an end of the hybrid round rod 100 prepared in step (b).

In the above-described step (b) before step (c), the metal tube 200 and the composite material round rod 300 may be integrated so that a side of the metal tube 200 is formed to be relatively longer than the length of the composite material round rod 300 to thereby provide a space defined by a length difference. The length difference between the metal tube 200 and the composite material round rod 300 may be determined within a range that satisfies a selected safety factor of the hybrid round rod 100 while satisfying the derived optimal ratio of the composite material round rod 300. The rod eye 400 includes a head 410 and a protrusion 420 screwed to an inner circumferential surface of the metal tube 200 in the space, so that the rod eye 400 is coupled to the end of the hybrid round rod 100 to complete a hydraulic cylinder rod.

Hereinafter, exemplary embodiments of a method of deriving an optimal ratio in step (a) will be described to help the understanding of present disclosure.

### Example 1

In Example 1, setting conditions fora hybrid round rod 100 were as follows: length L: 850 mm, outer diameter OD1: 30 mm, set applied load F: 4,000 kgf, end condition factor n: 1 (pinned-pinned), and set safety factor SF1: 2.5.

In addition, setting conditions for a metal tube 200 were as follows: material: SM45C, modulus of elasticity E: 21,000 kgf/mm², and density: 7.85 kgf/mm².

As illustrated in FIG. 3, in Example 1, under the above setting conditions, 30 mm was selected as a value of an outer diameter ODm of the metal tube 200, and 0, 3, 6, 9, 12, 15, 17, 18, and 21 mm were selected as values of an inner diameter IDm of the metal tube 200 for the value of the outer diameter ODm of the metal tube 200.

As a result of calculating a slenderness ratio A using the selected value of the outer diameter ODm of the metal tube 200 and each of the selected values of the inner diameter IDm thereof and then calculating a critical buckling load PC and a second safety factor SF2 using Euler's method, it could be found that when the inner diameter IDm of the metal tube 200 was 17 mm, the second safety factor SF2 was 2.557, which was the closest to the first safety factor SF1.

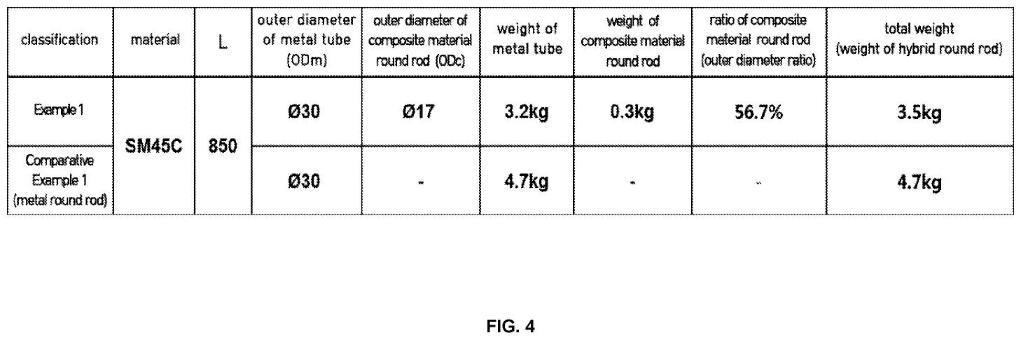

Referring to FIG. 4 in conjunction with the above, when the outer diameter ODm of the metal tube 200 was 30 mm, since the second safety factor SF2 was the closest to the first safety factor SF1, which was the set safety factor, when the inner diameter IDm of the metal tube 200 was 17 mm, a thickness Tm of the metal tube 200 was 6.5 mm (13 mm/2), an outer diameter ODc of a composite material round rod 300 was 17 mm, and the ratio of the composite material round rod 300 in the hybrid round rod 100 was 56.7%. In addition, the weight of the metal tube 200 was calculated as 3.2 kg, the weight of the composite material round rod 300 was calculated as 0.3 kg assuming that the composite material was CFRP, and the total weight of the hybrid round rod 100 was calculated as 3.5 kg. Here, the weight of a metal tube having an outer diameter of 30 mm, rather than the hybrid round rod 100, was calculated as 4.7 kg, and thus the weight could be reduced by 1.2 kg when manufacturing the hybrid round rod 100 according to the present disclosure.

### Example 2

In Example 2, setting conditions fora hybrid round rod 100 were as follows: length L: 650 mm, outer diameter OD1: 30 mm, set applied load F: 4,000 kgf, end condition factor n: 1 (pinned-pinned), and set safety factor SF1: 2.5.

In addition, setting conditions for a metal tube 200 were as follows: material: SM45C, modulus of elasticity E: 21,000 kgf/mm², and density: 7.85 kgf/mm².

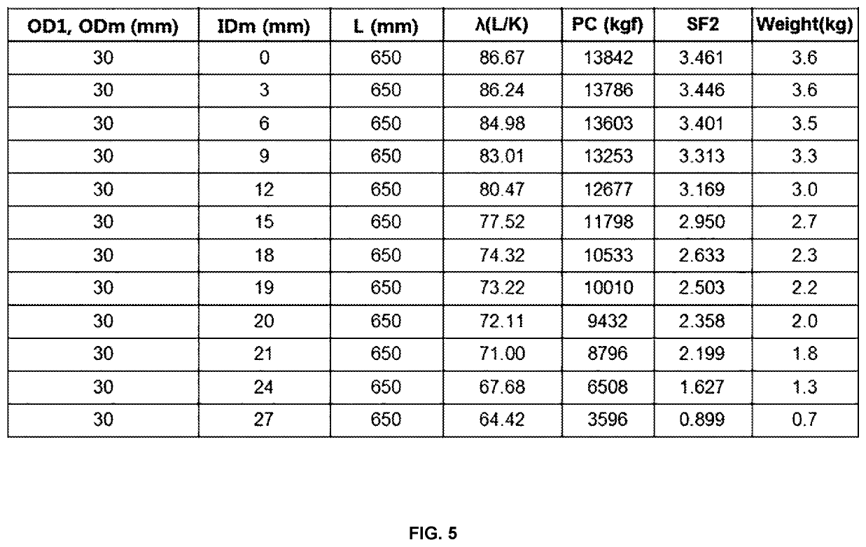

As illustrated in FIG. 5, in Example 2, under the above setting conditions, 30 mm was selected as a value of an outer diameter ODm of the metal tube 200, and 0, 3, 6, 9, 12, 15, 18, 19, 20, 21, 24, and 27 mm were selected as values of an inner diameter IDm of the metal tube 200 for the value of the outer diameter ODm of the metal tube 200.

As a result of calculating a slenderness ratio A using the selected value of the outer diameter ODm of the metal tube 200 and each of the selected values of the inner diameter IDm thereof and then calculating a critical buckling load PC and a second safety factor SF2 using Rankine's method, it could be found that when the inner diameter IDm of the metal tube 200 was 19 mm, the second safety factor SF2 was 2.503, which was the closest to the first safety factor SF1.

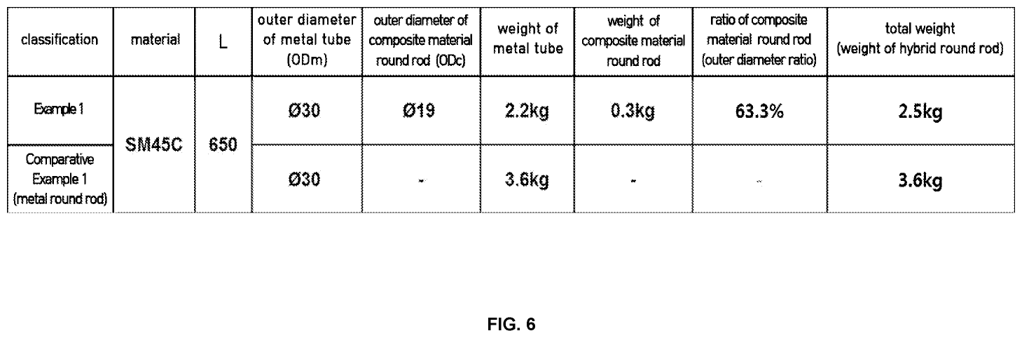

Referring to FIG. 6 in conjunction with the above, when the outer diameter ODm of the metal tube 200 was 30 mm, since the second safety factor SF2 was the closest to the first safety factor SF1, which was the set safety factor, when the inner diameter IDm of the metal tube 200 was 19 mm, a thickness Tm of the metal tube 200 was 5.5 mm (11 mm/2), an outer diameter ODc of a composite material round rod 300 was 19 mm, and the ratio of the composite material round rod 300 in the hybrid round rod 100 was 63.3%. In addition, the weight of the metal tube 200 was calculated as 2.2 kg, the weight of the composite material round rod 300 was calculated as 0.3 kg assuming that the composite material was CFRP, and the total weight of the hybrid round rod 100 was calculated as 2.5 kg. Here, the weight of a metal tube having an outer diameter of 30 mm, rather than the hybrid round rod 100, was calculated as 3.6 kg, and thus the weight could be reduced by 1.1 kg when manufacturing the hybrid round rod 100 according to the present disclosure.

The above description of the exemplary embodiments is intended to be merely illustrative of the present disclosure, and those skilled in the art will appreciate that various modifications, additions, and substitutions are possible, without departing from the essential characteristics of the present disclosure. Further, the exemplary embodiments described herein and the accompanying drawings are for illustrative purposes and are not intended to limit the scope of the present disclosure, and the technical idea of the present disclosure is not limited by the exemplary embodiments and the accompanying drawings. The scope of protection sought by the present disclosure is defined by the appended claims and all equivalents thereof are construed to be within the true scope of the present disclosure.

According to the present disclosure, by implementing weight reduction of hydraulic cylinder-related devices, there is an effect of contributing to improving energy efficiency in the use of fossil fuels, and further to preventing environmental pollution.

What is claimed is:

1. A method of manufacturing a lightweight hydraulic cylinder rod using a hybrid round rod including a metal tube and a composite material round rod provided inside the metal tube, the method comprising:
(a) selecting specifications of the hybrid round rod, selecting a population for the metal tube within a range of the specifications, and calculating a thickness of the metal tube that can reduce a weight of the hybrid round rod in the population to derive an optimal ratio between the metal tube and the composite material round rod;
(b) preparing the metal tube and the composite material round rod according to the optimal ratio derived in the step (a) and integrating the metal tube and the composite material round rod together to prepare a lightweight hybrid round rod; and
(c) coupling a rod eye to the lightweight hybrid round rod.

2. The method of claim 1, wherein the step (a) comprises:
(a-1) setting a first outer diameter (OD1), a length (L), a set buckling load (F), an end condition factor (n), and a first safety factor (SF1) of the hybrid round rod, and setting material and modulus of elasticity (E) of the metal tube;
(a-2) selecting a population for a thickness value of the metal tube in a range equal to or less than the first outer diameter (OD1), and calculating a slenderness ratio using the selected population for the thickness value and the length (L) to determine a method for calculating a critical buckling load (PC) of the population for the thickness value;
(a-3) calculating the critical buckling load (PC) for the population for the thickness value and a second safety factor (SF2) using the determined method, and calculating a third safety factor (SF3) closest to the first safety factor (SF1) among calculated second safety factors (SF2); and
(a-4) deriving the optimal ratio between the metal tube and the composite material round rod by using, as an optimal thickness, the thickness of the metal tube that can reduce the weight of the hybrid round rod among thickness values of the metal tube in the population for the thickness value, the thickness values corresponding to the third safety factor (SF3).

3. The method of claim 2, wherein the population for the thickness value of the metal tube in the step (a-2) is formed by
selecting the first outer diameter (OD1) as a value of an outer diameter (ODm) of the metal tube, and
selecting at least one of values in a range equal to or less than the selected value of the outer diameter (ODm) of the metal tube as a value of an inner diameter (IDm) of the metal tube.

4. The method of claim 2, wherein the method for calculating the critical buckling load (PC) of the metal tube in the step (a-2) uses either Rankine's method or Eulers method according to the calculated slenderness ratio.

5. The method of claim 2, wherein the step (a-4) is performed by calculating an outer diameter (ODc) of the composite material round rod from the optimal thickness of the metal tube, and
calculating a ratio of the composite material round rod by using the calculated outer diameter (ODc) of the composite material round rod and an outer diameter (ODm) of the metal tube.
